(19) United States
(12) Patent Application Publication
(10) Pub. No.: US 2008/0121141 A1
(43) Pub. Date: May 29, 2008

(54) Exothermic-enhanced articles and methods for making the same

(76) Inventors: Gregory W. Haggquist, Longmont, CO (US); Philip C. Haugaard, (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 11/985,733

(22) Filed: Nov. 16, 2007

Related U.S. Application Data
(60) Provisional application No. 60/859,628, filed on Nov. 16, 2006.
(60) Provisional application No. 60/967,059, filed on Aug. 30, 2007.

(51) Int. Cl. C09F 9/00; C09K 3/00; G01K 3/04

(52) U.S. Cl. 106/310; 252/194; 524/606; 374/102; 374/E03.004

(57) ABSTRACT

Exothermically-enhanced articles, such as those made of fabric, are provided. The enhancement allows for faster drying times. Enhancement may be provided by using activated particles exhibiting exothermic properties. The activated particles may be removably encapsulated with a protective substance that may be used to activate or deactivate the particles.

### CROSS-REFERENCE TO RELATED APPLICATIONS

This claims the benefit under 35 U.S.C. § 119(e) of copending U.S. Provisional Patent Application Nos. 60/859,628, filed on Nov. 16, 2006, and 60/967,059, filed Aug. 30, 2007, the disclosures of which are hereby incorporated by reference herein in their entireties.

### TECHNICAL FIELD OF THE INVENTIONS

The present disclosure relates to exothermic-enhanced articles and methods for making the same. The disclosure also relates to method for measuring the drying time of articles.

### BACKGROUND OF THE INVENTIONS

Materials may be used for several reasons, including their exothermic properties. An important property of materials is drying efficiency or drying time. Drying refers to the removal of moisture or liquid from a material. Drying may or may not be a heat-based process. For example, drying may occur by several methods including, but not limited to, freezing (e.g., the moisture solidifies and sublimes from the material), by evaporative drying (e.g., dry heated air is applied to the material to cause the moisture or liquid to evaporate), and by the application of microwaves and other radio-frequencies.

Regardless of the method used to dry a material, it is generally desirable that the material exhibit a high drying efficiency for that method and that an accurate method be available for making such a determination. A high drying efficiency in materials is desirable because it decreases the amount of time and energy required to dry an article produced from the material. For example, an article with a high drying efficiency may dry quicker after it is dampened, for example, by sweat. Furthermore, articles such as hospital gowns and beddings which are laundered frequently may last longer with improved drying efficiency as this reduces the harsh treatments that often result from subjecting these articles repeatedly to extended drying cycles.

### SUMMARY OF THE INVENTIONS

The present disclosure relates to exothermic-enhanced articles and methods for making the same. The disclosure also relates to method for measuring the drying time of articles. In one aspect of the present invention, a composition includes a base material and active particles in contact with the base material. The active particles may be capable of exhibiting exothermic properties which may be imparted to the composition, thereby improving the moisture management properties (e.g., the drying time or required drying energy) of the composition. In some embodiments, to protect the active particles from being deactivated during processing or production of the composition, the active particles may be encapsulated by a removable protective substance that prevents at least a portion of the active particles from being substantially deactivated by other substance or matter prior to removal of the removable protective substance. The removable protective substance may be subsequently removed to reactivate the portion of active particles to improve the moisture management properties of the composition. In some embodiments, the composition may be produced by combining an exothermic-enhanced substrate with one or more base materials. Suitable active particles include, but are not limited to, active particles capable of interacting exothermically with the base material. Suitable removable protective substances include, but are not limited to, substances having a particular chemical affinity for the active particle that enables the substance to adhere to the active particle when subjected to events that are possibly deleterious to the active particle, but also enables removal of the protective substance without damaging the active particle. The protective substance may be removed by, for example, dissolving or evaporating the protective substance.

In some embodiments, a performance-enhanced paint provided in accordance with principles of the invention includes a base paint material (such as, for example, a polyurethane or a polyacrylic paint) dissolved in a solvent. Active particles capable of exhibiting exothermic properties are added to the paint (e.g., during production of the paint or after production but prior to application of the paint). The active particles interact exothermically with the solvent and/or base paint material to produce heat that subsequently reduces the drying time of the paint.

Aspects of the invention also relate to a method for accurately measuring the drying time of an article. The method of measuring time disclosed by embodiments of the invention may be particularly well-suited to, but not limited to, measuring drying time for articles that, for example, exhibit adsorbance and whose drying times are therefore ill-suited to traditional methods of dry time measurements that are sensitive to changes in the weight of the article.

In some embodiments of the present invention, a method for determining the drying time of an article includes measuring under a controlled set of testing conditions an initial equilibrium temperature of the article after diffusing therein an amount of a liquid, such as water. As used herein, initial equilibrium temperature refers to a substantially constant temperature of an article following a relatively rapid drop in the temperature of the article after a liquid substance is introduced into the article. The temperature of article may be monitored under the controlled set of testing conditions to determine when a relatively rapid rise in temperature occurs and a final equilibrium temperature may be determined by measuring the temperature of the article following the relatively rapid rise. As used herein, final equilibrium temperature refers to a substantially constant temperature of an article following a relatively rapid increase in the temperature of the article after a liquid substance is introduced into the article. The drying time of the article may be determined based on the initial equilibrium temperature and the final equilibrium temperature. In some embodiments, the drying time of the article may be determined as the difference between the initial equilibrium temperature and the final equilibrium temperature. Drying time measured in accordance with the present invention may be adjusted to account for various testing conditions, including the room temperature and the humidity of the testing environment.

### BRIEF DESCRIPTION OF THE FIGURES

The objects and advantages of the invention will be apparent upon consideration of the following detailed description, taken in conjunction with the accompanying drawings, in which like reference characters refer to like parts throughout, and in which:

FIG. 1 is an illustrative graph comparing the dry time differences between a base material and an exothermically-enhanced material in accordance with some embodiments of the present invention;

FIG. 2 is a block diagram of an illustrative arrangement for measuring the dry time of a fabric in accordance with some embodiments of the present invention;

FIG. 3 is a graph of illustrative data retrieved regarding the dry time of several fabrics in accordance with some embodiments of the present invention; and

FIG. 4 is a block diagram of an illustrative arrangement for performing a drip demonstration in accordance with some embodiments of the present invention.

### DETAILED DESCRIPTION OF THE INVENTIONS

Generally, when two or more substances interact in a reaction or process, energy may be exchanged with the surrounding environment. Typically, energy may be consumed as input to the process or reaction, produced as a by-product or output of the process or reaction, or both. As a result of this energy exchange, a reaction or process may add a net negative or a net positive amount of energy to the surrounding environment. An exothermic process or reaction is one that adds a net positive amount of energy in the form of heat to the surrounding environment (e.g., the process consumes less energy than it produces). Exothermic reactions may be chemical, physical, or both. Examples of exothermic reactions include, but are not limited to, adsorption, respiration processes, combustion processes, freezing, reactions between acid and water, and any combination thereof.

An active particle may have exothermic properties if it interacts exothermically (i.e., releases heat when it reacts) with one or more substances. An exothermic-enhanced article may be derived in accordance with one embodiment of the present invention by combining active particles having exothermic properties with one or more base materials to improve the drying efficiency of the resultant article in a heat-based drying process such as drying by evaporation.

Exothermic particles may also reduce the energy consumed when using a dryer to dry an article. An exothermic-enhanced article produced according to the principles of the present invention may release heat into the drying environment to supplement the energy supplied by the dryer and thereby improve the drying rate of the article in dryer. For example, active particles embedded in an article may adsorb liquid introduced into the article and undergo an exothermic reaction. Because the drying process of the dryer may be temperature-dependent in which the drying rate may increase as the process temperature increases, the heat released by the exothermic process of the active particles may increase the temperature of the drying process and thereby improve the drying rate of the dryer beyond the drying rate that may otherwise result from the energy supplied by the dryer.

Accordingly, exothermic-enhanced materials produced according to the principles of the present invention may be used in a wide variety of products including, but not limited to, for example, gowns, bedding, curtains, towels, bathroom accessories, kitchen accessories and in any product, process, or environment (e.g., Hospitals and hotels) where efficient drying may be desired.

In some embodiments, exothermic particles may be used according to the principles of the present invention to remove germs or the like from an article, process, or environment. For example, the heat released by adsorption may raise the temperature of the article, process, or environment to levels that may be fatal to certain harmful germs, microbes and the like.

Base materials that may contain an exothermic-enhanced article may include, but are not limited to, polyester, nylon, polyacrylic, polypropylene, polyurethane, thermalplastics, PTFE (e.g., Teflon®), polycarbonates, polyalkanes, polyethylenes, polystyrenes, poly-vinyl compounds, epoxy, siloxane based reaction polymer, glue, cross-linking polymer, polymers, fibers, cotton, acetate, acrylic, aramid, bicomponent, lyocell, melamine, modacrylic, nylon, olefin, PBI, rayon, spandex, water, oil, aerosols, perfumes, any other suitable materials, or any combination thereof.

Certain particles may be used to add performance properties to materials in different forms such as gases, liquids, and solids. These particles may have properties that are suitable for odor adsorption, moisture management, ultraviolet light protection, chemical protection, bio-hazard protection, fire retardance, anti-bacterial protection, anti-viral protection, anti-fungal protection, anti-microbial protection, any other suitable factors, or any combinations thereof.

These particles may provide such properties because they are active. That is, the surface of these particles may be active. Surface active particles are active because they have the capacity to cause chemical reaction, physical reactions, or both at their surface. Such reactions may include, for example, adsorbing or trapping substances, including substances that may themselves be a solid, liquid, gas, or any combination thereof. Examples of substances include, but are not limited to, pollen, water, butane, and ambient air. Certain types of active particles may have an adsorptive property (e.g., activated carbon) because each particle has a large surface area made up of a multitude of pores (e.g., pores on the order of thousands, tens of thousand, or hundreds of thousands per particle). These pores may provide the particle or, more particularly, the surface of the particle with its activity (e.g., capacity to adsorb). For example, an active particle such as activated carbon can adsorb a substance (e.g., butane, methane, water, and other gases and liquids) by trapping the substance in the pores of the activated carbon.

Active particles may include, but are not limited to, activated carbon, aluminum oxide (activated alumina), silica gel, soda ash, aluminum trihydrate, baking soda, p-methoxy-2-ethoxyethyl ester Cinnamic acid (cinoxate), zinc oxide, zeolites, titanium dioxide, molecular filter type materials, and other suitable materials. Activated carbon that may be included in the exothermic-enhanced article of the present invention may be derived, for example, from wood, bamboo, coal, coconut, or bithmus. Activated carbon may also be derived synthetically.

Exposing the active particles to a substance may reduce or permanently negate the activity of the active particles by blocking or inhibiting the pores, thus reducing the surface activity of the active particles. That is, when the pores are blocked or inhibited with a substance, those blocked or inhibited pores may be prevented from further adsorption. However, the adsorptive capacity of active particles may be increased or restored by removing the substance that is blocking or inhibiting the pores. Hence, active particles can be rejuvenated or reactivated, for example, by being heated to a predetermined temperature.

A common problem associated with active particles is that they may lose activity or become permanently deactivated before, during, or after a process that incorporates the particles into a material (e.g., a base material). For example, active particles may lose a portion of their activity when exposed to contaminants in the ambient environment prior to being used in a process or during shipment from the active particle manufacturer to the end-user. Regardless of how particle activity is negated or reduced, such negation or reduction thereof may adversely affect the product produced by the process. For example, if particle activity is reduced, heavier particle loading may be required to make up for the reduction in activity, potentially resulting in particle loadings that affect the inherent characteristics (e.g., hand and feel) of the material treated in the process. Moreover, heavier particle loading may require increased binder loadings, which may further affect the inherent characteristics treated in the process. Thus, it will be understood that even the smallest diminution of particle activity may adversely affect the material because of the cumulative affects (e.g., additional particles and binder loadings) stemming from that reduction.

Active particles may be “protected” through use of at least one removable protective substance (or removable encapsulant). Introduction and removal of the protective substance results in enhanced active performance, such as for example, enhanced drying, enhanced adsorption, enhanced moisture management, enhanced anti-microbial functionality, enhanced anti-fungal functionality, enhanced anti-bacterial, and enhanced catalytic interaction as compared to performance of the active particles if the protective substance had not been introduced. Protected active particles may enhance the effective performance of materials incorporating such active particles through use of the removable protective substance.

A more specific aspect of protected active particles is that the removable protective substance preserves the activity of active particles against premature deactivation caused by deleterious or non-deleterious substances or matter (such as deleterious adsorption of a base material during extrusion of a composition including the active particles and base material or a drawing of a film including the active particles and base material solution), such active particles having the ability to interact through particle surface exposure or particle surface proximity to various substances or matter (of any phase). Deleterious substances are substances that cannot be easily removed or cannot ever be removed from an active particle and therefore reduce the active particle's capacity for further adsorption. For example, a deleterious substance such as a molten polymer may permanently deactivate active particle. A molten polymer, for example, cannot be removed without damaging the active particle or the substance surrounding the active particle.

Other substances that are prematurely adsorbed may be relatively easy to remove. That is, these types of substances may be removed using methods of rejuvenation or reactivation that do not damage the active particles or the surrounding substance. For example, when a non-deleterious substance, such as methane, is adsorbed, it may be removed from the active particle by heating the particle.

Such preservation is achieved through use of at least one removable protective substance (or removable encapsulant) to maintain the active particles in a protected state to prevent premature deactivation, in a manner enabling removal of the protective substance during reactivation to permit subsequent active performance by the active particles. When an active particle is in a protected or deactivated state, its further performance interaction is temporarily or permanently reduced or negated altogether. If the deactivated state is the result of a deleterious event (such as for example, adsorption of a deleterious substance or matter), the further interaction at the affected areas of the particle is more permanent. Deleterious premature deactivation may occur in a variety of circumstances, including for example, when the active particle is introduced to a deleterious slurry or exposed to an extrusion process or other deleterious event or material at a time that will result in the inability of the particles to provide active performance at the desired time (such as for example, drawing a film of the material containing the particles). Deleterious deactivation can occur and not constitute premature deactivation, if such deactivation occurs at the desired or appropriate time (for example, after drawing of a film and in connection with an intended target substance or matter).

In the case of adsorptive activity and moisture management, when a removable protective substance is introduced to the active particle prior to exposure of the active particle to a deleterious event or other adsorptive performance limiter, the active particle is placed in a protected or deactivated state, limiting performance adsorption of the active particle for the time when premature deactivation is to be avoided. Reactivation by removal of the protective substance re-enables the active particles to interact with other substances or matter, such as for example, target substances or matter in the environment of a finished article incorporating the active particles.

When deactivation is the result of performance activity (in this case, performance adsorption) by the particles when incorporated in an article (adsorption at a time after removal of the removable protective substance), performance activity may be restored through rejuvenation (or other reactivation) if desired and if such deactivation was due to a non-deleterious event. A process of rejuvenation may include, for example, a washer/dryer cycling of a exothermic-enhanced article of the invention. Another process of rejuvenation may include, for example, irradiating the exothermic-enhanced article with different wavelengths of light.

With respect to the use of active particles to enhance performance activity in a base material (whether the activity is adsorptive, anti-microbial, dependent upon exposure of the surface of the particle to an environmental target of interaction, or simply an activity that is inhibited, enhanced, or both through use of a removable protective substance), use of at least one removable encapsulant also enables use of fewer active particles in the embedding substance or matter (or in a resultant article) to achieve effective active performance, thereby reducing potential degradation of other physical properties (for example, strength or feel) of the base material, matter or resultant article (e.g., exothermic-enhanced article).

The use of a removable protective substance (sometimes referred to herein as removable encapsulant or removable protective layer) can also be designed to enable time-delayed exposure of a portion of active particles to effect an initial exposure or enhanced active performance at a later time (including for example, enhancement resulting from protection against premature deactivation).

Removable protective substances can include, but are not limited to, water-soluble surfactants, surfactants, salts (e.g., sodium chloride, calcium chloride), polymer salts, polyvinyl alcohols, waxes (e.g., paraffin, carnauba), photo-reactive materials, degradable materials, bio-degradable materials, ethoxylated acetylenic diols, starches, corn starch, lubricants, glycols, mineral spirits, ammonium carbonate, any other suitable substances, or nay combination thereof. Specific examples of such protective substances that are suitable for protecting active particles include the Surfynol AE03, AE02, 485W, 485, 2502, and 465 water soluble surfactants, sold by Air Products and Chemicals Corporation, of Allentown, Pa., waxes sold as Textile Wax-W and Size SF-2, by BASF Corporation, of Charlotte, N.C., and waxes sold as model numbers Kinco 878-S and Kinco 778-H by Kindt-Collins Company, of Cleveland, Ohio. Glycols sold by DOW Chemical Company under the name DOWANOL (DPnP, DPM, or DPMA) and TRITON CF-10 may also be used as a suitable protective substance.

An advantage of using the removable protective substance is that it increases the effective performance of the activated particles incorporated into an exothermic-enhanced article according to the invention. This is particularly advantageous for use in the exothermic reaction, as greater quantities of heat may be released for predetermined area of the article, at least compared to prior articles having active particles incorporated therein.

A more detailed explanation of protected active particles, the preparation and applications thereof, and removal of the protective substance can be found, for example, in U.S. patent application publication no. 2004/0018359, which is incorporated herein by reference in its entirety. It will be understood that active particles may be protected by mixing the active particles into a slurry of at least one protective substance, which may or may not be diluted with a solvent (e.g., water).

Several different exothermic-enhanced articles derived from mixtures having different compositions (e.g., weight percentages) of one or more different base materials, one or more different active particles, and one or more different protective substances may be provided and used in exothermic-enhanced articles according to the invention. In some embodiments, the base material may be a polymer base material belonging to the polymer families of polyethylene, polyester, nylon, polypropylene, polyurethane, and polyacrylics. The loading of activated carbon in the exothermic-enhanced article may be a predetermined % w/w (percent weight of the carbon compared to the weight of the exothermic-enhanced article). The predetermined % w/w may be such that the exothermic-enhanced article has sufficient structural integrity to sustain repeated gas collection and extraction cycles. It is understood that the % w/w of activated carbon in the exothermic-enhanced article may depend on a number of factors such as, for example, the type of base material used, the “final form” of the sheet (whether the sheet is a woven, a non-woven, or a film), the intended use of the sheet, and any other suitable factors.

The loading of activated carbon may range from 0.1% w/w to about 50% w/w, 0.5% w/w to about 50% w/w, 0.5% w/w to about 10% w/w, 10% w/w to about 50% w/w, 20% to about 50% w/w, 30% w/w to about 50% w/w, 40% w/w to about 50% w/w, 10% w/w to 20% w/w, 15% w/w to 25% w/w, 20% w/w to 40% w/w, or any other suitable range.

In some embodiments, the exothermic-enhanced article may be embodied in a film or tarp-like sheet. An advantage of a film-based exothermic-enhanced article may be that it possesses a certain degree of imperviousness to water penetration, thereby providing it with a water resistant, or water proof property. A film-based exothermic-enhanced article may be produced as follows.

An aqueous mixture of base material, activated carbon, and a removable protective layer may be applied to a substrate such that the mixture forms a layer or film thereon, prior to being cured. The substrate may be a substance for which the cured mixture is intended to be permanently affixed such as, for example, a woven, a non-woven, paper or knitted material. In approaches for which the cured mixture is intended to be removed and used independent of a substrate, the mixture may be applied to a release paper or other substance that has a low affinity for adhering to the cured mixture. The mixture may be cured by subjecting it to a predetermined temperature for a predetermined period of time. Any suitable technique for effecting cure may be used such as, for example, a conventional oven, IR heating, or other suitable approach.

The base material included in the mixture from which the film is derived may include a polyurethane solution, an polyacrylic solution, polyurethane solutions, 1,3 propanediol terephthalate solutions, or any other suitable solution. The base material may include water and other ingredients such as cross-linking polymers. If desired, a combination of at least two different base materials may be used (e.g., a combination polyurethane and acrylic solution). An example of a polyurethane that may be used is a breathable polyurethane available from Noveon Corporation of Cleveland, Ohio. See, for example, U.S. Pat. No. 6,897,281 for a detailed discussion of a polyurethane, the disclosure of which is incorporated by reference herein in its entirety. In some embodiments, the base material may include Noveon's Permax polyurethane coating compound. In some embodiments, the base material may include Noveon's Permax polyurethane coating compound, an acrylic polymer, and an extra cross-linking agent.

The protective substance may be removed from the activated carbon, thereby yielding a exothermic-enhanced article in accordance with the principles of the present invention. The protective substance may be removed when the mixture is curing, or when subjected to a process (e.g., washing/drying cycle) or agent (e.g., light, solvent, bacteria) that causes the protective substance to be removed. It is understood that not all of the protective substance may be removed. That is, a portion of it may remain permanently affixed to the base material.

In some embodiments, the exothermic-enhanced article may be embodied in a woven sheet. The woven sheet may be derived from yarn extruded from a mixture of base material, activated carbon, and a protective substance. The extruded yarn may be woven into an article that forms an exothermic-enhanced article. If desired, the extruded yarn may be interwoven with yarn that does not contain active particles to provide an article constructed from a blend of yarns. After the woven article is constructed, it may be subjected to a process or conditions which cause at least a portion of the removable protective substance to be removed.

In some embodiments, the exothermic-enhanced article may be embodied in a non-woven sheet. The non-woven sheet may be derived from “chopped-up” fibers or staple fibers extruded from a mixture of base material, activated carbon, and protective substance. The fibers may then be fused together to form a non-woven structure. After the non-woven article is constructed, it may be subjected to a process or conditions which cause at least a portion of the removable protective substance to be removed.

As used herein, a woven material refers to any material held together mechanically by looping the constituent yarns around each other in a non-random manner. The term woven is intended to refer to (1) classical woven materials in which a material is composed of two yarns, known as the warp and the weft (or fill); and to (2) knitted materials which generally consist of yarns that run in the same direction rather than perpendicular directions and, like classical woven materials, are held together mechanically. Examples of woven materials include, but are not limited to, fabric materials, such as those used in apparel applications, and sheet materials, such as those used in non-apparel applications. The term yarn is intended to refer to any continuous strand of material, such as, for example, yarn, fiber, thread, or string.

In contrast, a non-woven material is made by fusing fibers together. This results in a random three-dimensional structure containing free volume, or pores. These pores have a wide range of volumes. This internal pore structure results in gas, liquid and solid permeability of the non-woven material.

An exothermic-enhanced article may be made using an air dispersion method for treating an embedding substance (e.g., woven or non-woven material). In general, an air dispersion method (a) entrains active particles in a gaseous carrier, (b) disposes a first face of an embedding substance with the entrained gaseous carrier, (c) maintains a pressure drop across the embedding substance from the first face to a second face of the embedding substance so that at least some of the entrained active particles are incorporated into the embedding substance, and (d) fixes the active particles to the embedding substance. The above description of the air dispersion method is not intended to be a comprehensive explanation, but merely an illustrative example of such a method. A person skilled in the art will appreciate that air dispersion methods can be performed in a number of different ways. A detailed explanation of an air dispersion method can be found, for example, in U.S. Patent Application Publication No. 2003/0060106, published Mar. 27, 2003, the disclosure of which is hereby incorporated herein by reference in its entirety. If desired, the air dispersion process may entrain active particles which are encapsulated with a removable protective layer.

The fixing step, referred to above at step (d), may be the step that permanently attaches the particles to the embedding substance. In one approach, this step may be implemented by using a solution that contains a binding agent and a solvent (e.g., water). This solution is applied to bind the particles to the embedding substance. The binding agent serves as the “glue” that secures the particles to the embedding substance, but the water serves as the “carrier” for carrying the binding agent through the embedding substance to the particles. Because the solution may be comprised mostly of the solvent, the solution has the propensity to pull away from the active particles as it is adsorbed by the embedding substance, exposing portions of the encapsulant. Thus, as the solvent is absorbed by the embedding substance, it also carries the binding agent away from the particle (e.g., the solution pulls away from the portion of the particle that is not in direct or nearly direct contact with the embedding substance). However, the portion of the active particle that is in contact with the embedding substance may be unable to shed the solution. This advantageously enables the binding agent to form a bond between the particle and the embedding substance.

The process of fixing can cause unprotected active particles to deactivate. For example, if the solution does not dry quick enough, the binding agent may seep out of the embedding substance and enter the pores of unprotected active particles. This problem can be avoided by encapsulating the particles prior to being entrained in the gaseous carrier.

Therefore, applying the encapsulant to the active particles before being subjected to the air dispersion process may promote preservation of the active particles while being subjected to a substance that may cause premature deactivation. After the encapsulated particles are attached to the embedding substance, rejuvenation agents may be applied to remove the encapsulant. Thus, any portions of the encapsulated particles that are not covered by the binding agent are removed, which results in exposing those particular portions to the ambient environment.

An exothermic-enhanced article according to the principles of the present invention may be produced using a padding method that is used to treat an embedding substance. The padding method involves passing a material (e.g., yarn, fabric, etc.) through a bath of active particles. As the embedding substance passes through the bath, the active particles adhere to the embedding substance. The padding process can agitate the particle bath to prevent formation of channels that could prevent adequate active particle incorporation. In addition, the padding method can impress the active particles into the embedding substance with a roller as it passes through the padding chamber.

The active particles can be permanently attached to the embedding substance through application of a binding agent. The binding agent is typically applied to the embedding substance as a solution either before or after the embedding substance passes through the padding chamber. The same fixing method as that described above in conjunction with air dispersion method may be applied to this method. The above description of the padding process is not intended to be an exhaustive discussion, but merely serves to provide an illustrative example in how a padding method may be implemented. After the particles are fixed, the material may be used to provide the exothermic-enhanced article. A detailed discussion of the padding method may be found, for example, in U.S. patent application publication No. 2002/0197396, published Dec. 26, 2002, the disclosure of which is hereby incorporated herein by reference in its entirety.

An exothermic-enhanced article may be produced by applying a liquid suspension or mixture of a binder, active particles, and removable protective layer to an embedding substance (e.g., woven, non-woven, or film).

An exothermic-enhanced article may be produced by using a xerographic method for treating an embedding substance. The xerographic method uses the principles of electrostatic or magnetic attraction to transfer a toner formulation from a hopper to a drum assembly. The drum assembly is an electrically charged or magnetically polarized assembly that rotates at a predetermined speed. As the drum assembly rotates, the toner formulation is attracted to and retained by selective (e.g., magnetically or electrically charged) portions of the assembly. Then, as the assembly continues to rotate, it impresses the toner formulation onto the embedding substance. Then the embedding substance is subjected to heat, which causes the toner formulation to be permanently fixed to the material (e.g., binding agents in the toner formulation plasticize and bind the particles to the embedding substance). A detailed discussion of the xerographic method may be found, for example, in U.S. Patent Application Publication No. 2002/0197547, published Dec. 26, 2002, the disclosure of which is hereby incorporated herein by reference in its entirety.

The toner formulation may include, but is not limited to, active particles (e.g., activated carbon), binding agents, and additives such as charge control particles, magnetic control particles, coloring agents, or any combination thereof. If desired, the active particles may be encapsulated with a removable protective layer (e.g., a wax) prior to being added to the toner formulation. This encapsulant can preserve the properties of the active particles while they are being permanently attached to the embedding substance.

A mechanism by which an exothermic-enhanced article may exhibit improved drying efficiency is illustrated using the example of an evaporative drying process. As explained above, an evaporative drying process may be generally understood as a drying process that extracts water or any other liquid from an environment by application of heat to convert and release the liquid in gaseous form. Because the rate of evaporation typically increases with the process temperature, an evaporative drying process is also a temperature-dependent.

Natural drying time of a fabric has been historically measured by saturating a piece of fabric with water and measuring the time it takes the fabric to return to its original weight. A limitation of this method of measuring fabric drying time is that it fails to accurately determine the drying time of fabrics that exhibit adsorbency. This failure is due in part to the fact that the weight of adsorptive particles may vary based on which substances are adsorbed or desorbed. As a result, any weight change may not be accurately attributed to the drying process.

As a result of this deficiency, a measurement process that is substantially transparent to weight variations is needed to measure the drying time of exothermic-enhanced articles as they may fall in the category of fabrics having adsorptive properties. Natural drying time, as defined herein, refers to the amount of time it takes the material to return to room temperature after water or a water-based substance is added to the fabric at room temperature.

When a liquid such as water is added to an article such as a piece of fabric at room temperature, the temperature of the fabric quickly drops to an equilibrium temperature. This equilibrium temperature is depends on the room temperature, the base material, the rate of evaporation and the relative humidity (RH) of the evaporative process. The temperature of the article remains substantially constant at this equilibrium during the evaporation process. When the evaporation process is completed, the temperature of the article rises quickly to a dry point temperature, also below room temperature and then slowly rises to room temperature. For the purposes of measuring drying time, the article is considered dry at the transition point between the fast rise in temperature and the slow rise to room temperature. The time difference between when the temperature drops quickly and rises quickly is considered the dry time of the article.

Exothermic-enhanced articles produced according to the principles of the present invention may exhibit improved drying time and drying efficiency due to the exothermic properties of the embedded active particles. When an active particle having exothermic properties, such as activated carbon, is exposed to a liquid such as water, the liquid is adsorbed by the activated carbon and heat is released to the surrounding environment. In an exothermic-enhanced article, this heat results in a higher initial equilibrium temperature when the liquid is initially added. The heat produced by the exothermic reaction also adds energy to the evaporation process, causing an increase in the rate of evaporation, and hence drying rate. The higher initial equilibrium temperature and the increased process temperature both contribute to reducing the drying time and input energy of the drying process, thereby increasing the drying efficiency of the exothermic-enhanced article.

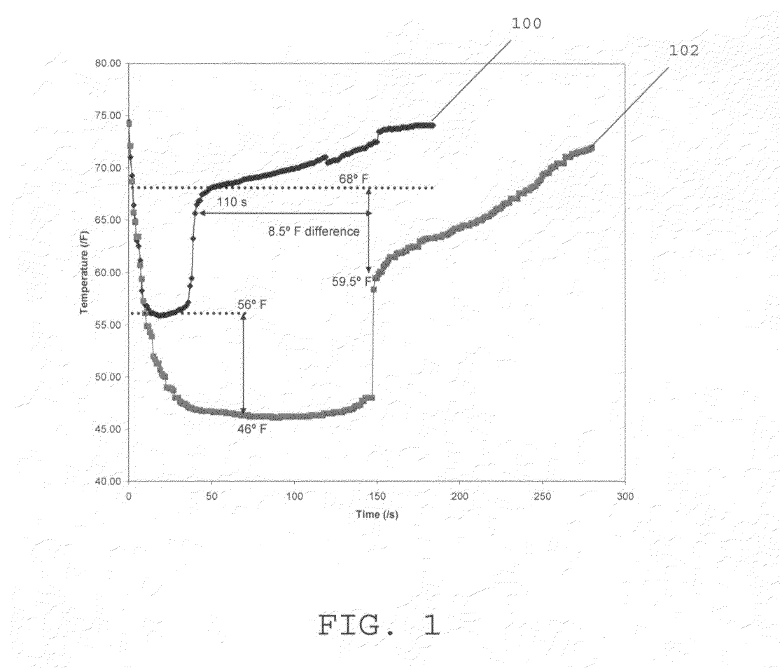

FIG. 1 shows results of drying time improvements that may be achieved by an exothermic-enhanced article compared to a non-enhanced article of the same base material. According to FIG. 1, both the exothermic-enhanced article (represented by curve 100) and the base material (represented by curve 102) are at about 750 F prior to the addition of a cooling liquid at Time 0 seconds. When the cooling liquid is added to the base material, the initial equilibrium temperature is 46° F., compared to 56° F. for the exothermic-enhanced article. Furthermore, the evaporative process takes about 150 seconds to complete, compared with about 40 seconds for the exothermic-enhanced article. Moreover, the dry point temperature of the base material is substantially lower, at 59.5° F., than the 68° F. for the exothermic-enhanced article.

The exothermic-enhanced article of the present invention and the methods of making the same may be applied to produce garment products that maintain the inherent characteristics of the base materials, while simultaneously enhanced by the performance characteristics of the active particles incorporated therein.

It is also understood that although the principles of the present invention have been illustrated using exothermic-enhanced articles in which an exothermic system is incorporated into the article itself, the present invention may be applied to drying processes as well without deviating from the principles of the invention.

Thus, exothermic-enhanced articles and methods for making the same are provided. A person skilled in the art will appreciate that the present invention can be practiced by other than the described embodiments, which are presented for purposes of illustration rather than limitation.

There are several reasons to measure the dry time of fabrics. One reason is to understand the performance of a fabric while a person is wearing a garment in order to determine a comfort level for the wearer. In general, the faster the drying time of a piece of fabric (after it becomes wet from either perspiration or external effects such as spills or rain), the higher the level of comfort of the garment. Longer dry times lead to either over cooling from the slow evaporation of the water or a persistent an uncomfortable feeling of being wet. A second reason is to determine the amount of energy or the time required to dry the garment in a dryer or other drying device. In general, faster dry times correlate to less energy consumed from the dryer or ease of drying a garment on a clothes line. Therefore, an accurate understanding or measure of the drying time of fabric is important to, for example, determine suitable uses of the fabric.

One way in which to determine the dry time of a fabric is to monitor the weight change of the fabric. Using this method, a fabric is weighed dry and then saturated with water and the weight of the fabric is monitored until the original weight of the fabric is achieved. A second method that is used is to monitor the electrical resistance of the fabric. When the fabric is wet, the fabric will have a lower resistance, as the fabric dries the resistance increases. Both of these methods start with a saturated fabric and depend on static drying in air. Because each piece of fabric is going to absorb a different level of water (i.e., they well have different amounts of water), the starting points for measuring the dry time for each fabric will be different. In the case where a person is wearing a garment and is perspiring, the garment is not necessarily saturated with water. The person is perspiring at a specific rate and the perspiration is coming off continually. Thus, for a test to mimic this event, a set amount of water may be used in the test and a demonstration of a continuous dripping or perspiration may be needed.

In accordance with some embodiments of the present invention, a determination of when a fabric is dry may be made using temperature as a monitoring parameter. In some embodiments of the present invention, a measurement may be made to indicate when fabrics are dry after adding to the fabric a known or predetermined amount of water.

Measuring the dry time of a fabric may be based on the cooling effect of evaporation, such as for example, when water is evaporating from a fabric. In this illustrative embodiment, the water evaporation process is endothermic and thus cools the surface of the fabric. When there is no longer any water on or in the fabric the evaporation process stops and the surface temperature of the fabric rises quickly. This inflection of the temperature is the point when the fabric may be considered dry.

The following experiment was performed using a 6″ by 6″ fabric sample, and is intended merely to demonstrate the drying measurement process described above.

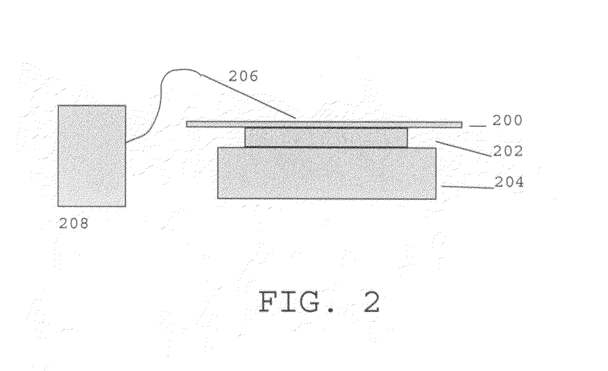

It will be understood that the invention is by no means limited by this illustrative experiment. With reference to FIG. 2, fabric 200 is mounted in a embroidery hoop 202 which is attached to a fan 204. Fan 204 may be run by a DC power supply that continuously supplies about the same amount of voltage and current to fan 204. Fan 204 runs at about the same speed for every test. A thermocouple 206 with, for example, a Teflon sleeve is mounted to touch the top of fabric 200. A known amount of distilled water (e.g., 0.2 mL, in this example) that is at room temperature may be dropped on fabric 200 at the location of thermocouple 206. The temperature of fabric 200 is recorded by a meter 208 connected to a computer. The temperature is monitored before and after the water is added to fabric 200. The point at which the temperature drops is stated to be time zero. The point at which the temperature rises rapidly is termed the end time. The difference between the end time and time zero is the dry time. Samples are preferably measured under the same room conditions when performing comparisons. The relative humidity and room temperature all play a role in the dry time.

Advantages of this test for measuring dry time include the ability to get reproducible results, being able to obtain accurate results because of the fast inflection point, the ability to determine the start and end point because of the continual monitoring, the ability to eliminate the absorbance factor of fabrics because the comparison is based on equal amounts of water (or any other suitable liquid), and the ease of performing the measurement.

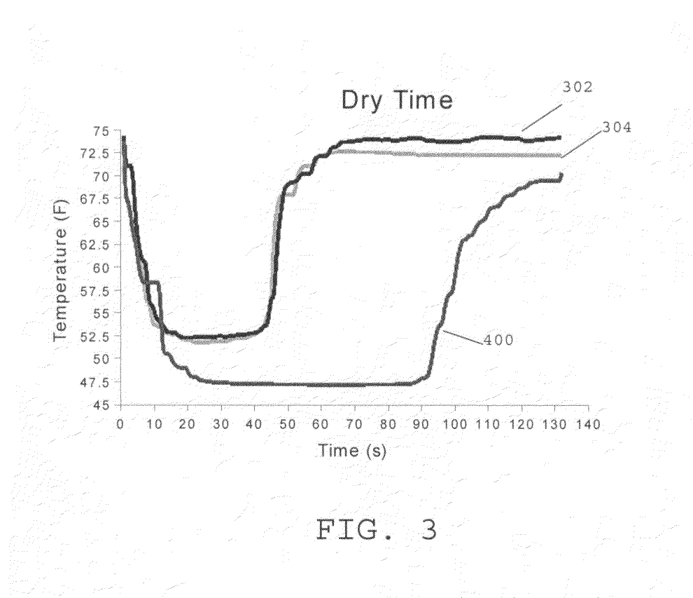

The graph illustrated in FIG. 3 represents data collected on several fabrics. The control fabric 300 is 100% polyester fabric, fabric 302 contains 47% Cocona yarn (i.e., activated carbon from coconut shells), and fabric 304 contains 47% yarn with a zeolite additive. All three fabrics are the same construction, same weight (135 g/m²), and same processing. Both the activated carbon and zeolite yarns contain materials which adsorb water. The adsorbance process is exothermic and adds heat to the system. In addition, the large surface area of the additives may aid in the drying of the fabric. Time zero is where the temperature begins to drop, this is when the water was dropped on the fabric. The end time is the middle of the knee of the temperature curve, this is the point when the fabric is dry. The end time minus time zero is the dry time. The dry time for control fabric 300 is 110 seconds, for fabric 302 is 55 seconds, and for fabric 304 is 55 seconds.

A laboratory test is good at generating comparative data to determine the performance features of a product. However, in order to understand what the lab data represents, often a demonstration is required. To demonstrate the efficacy of the faster dry time facilitated by the present invention, a drip demonstration is provided. The drip demonstration of the present invention may involve a water dripping source that may deliver the same amount of water continually at the same rate to two or more fabrics. A liquid pump with multiple tubes (i.e., one or more per fabric) may be used to deliver the same amount of water to each fabric. The fabrics may be mounted in embroidery hoops (or in any other suitable stabilizer) on top of respective fans (or any other suitable air sources) connected to a common power source. Alternatively, multiple identical power sources may be used (e.g., one per fan). Thus, the drip demonstration of the present invention delivers the same or substantially the same amount of water and blows the same or substantially the same amount of air across the different fabric samples. The drip demonstration shows how the slow drying fabric saturates with water while the fast drying fabric is able to keep up with the perspiration or the water drip rate. The rate may be adjusted to find where the fast drying fabric reaches a steady state.

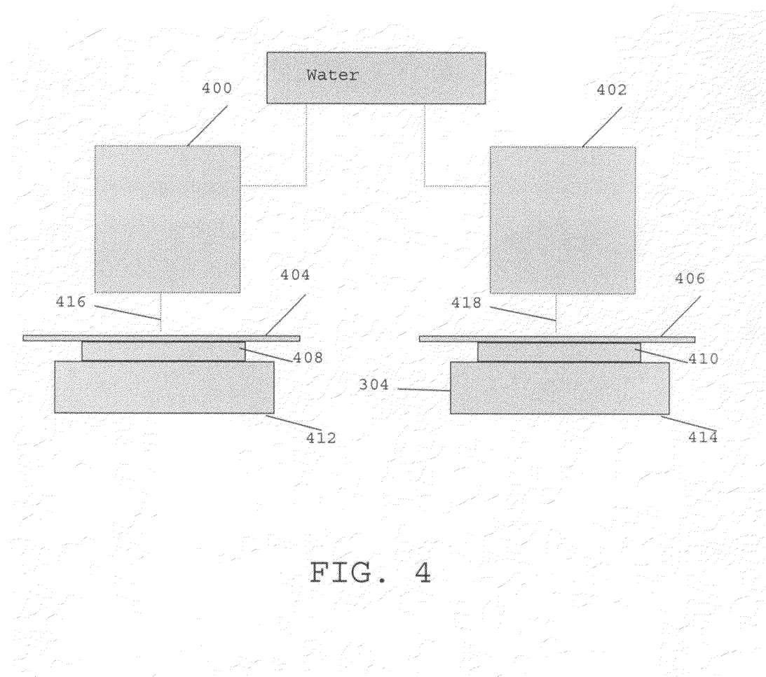

In some embodiments, as illustrated in FIG. 4, a demonstration unit may include two water delivery systems 400 and 402 (e.g., parastalic pumps, separatory funnels, or any other water delivery system) which drop water 416 and 418 equally or substantially equally over two fabrics 404 and 406 mounted using embroidery hoops 408 and 410 on top of fans 412 and 414. The two fans 412 and 414 may be the same type running at the same speed. Water 416 and 418 is dropped on fabrics 404 and 406 where the water is adsorbed and moves out on fabrics 404 and 406. The faster drying fabric is able to evaporate the water at the same rate as it is dropped on the sample. The slower drying fabric becomes saturated and starts to drip water.

The present invention may be used in the context of a performance-enhanced paint, and more particularly, to improving the drying time of paint by the addition of active particles.

Paints may be classified as pigments doped into a polymer material. Generally speaking, paints are able to dry by driving off added solvents, cross-linking of the polymer system, or both. Polyurethane and polyacrylic paints are two families of paint that may require the solvent, which may be organic or aqueous, to evaporate in order to dry the paint.

In some embodiments of the present invention, additives, such as active particles that have adsorbance properties, may be added to the paint. Evaporation of the solvent may be sped up, and the dry times of these paints may be improved as a result. In these embodiments, the active particles exhibit exothermic properties when they adsorb, thereby releasing heat that aids in the evaporative process. Additives may include activated carbon, zeolites, silica gel, aluminum oxide, desiccants, any other suitable material or chemical which exhibits adsorbance, or any combination thereof.

Any suitable method or system may be used to incorporate the additives or active particles into the paint. In some embodiments, the active particles may be added to the paint to achieve the desired improved drying while avoiding premature deactivation of the active particles by encapsulating the active particles using a removable encapsulant during processing of the paint materials. A detailed description of encapsulated active particles is described in U.S. patent application Ser. No. 11/226,524, which is incorporated by reference herein in its entirety. Where active particles are encapsulated during processing of the paint, the encapsulant may be removed during drying of the paint, such as for example, during application of the paint. In some embodiments, instead of, or in addition to, incorporating additives during processing of the paint, the additives may be added at the time of use directly to the paint.

Thus, methods and systems for measuring the dry times of fabrics as well as methods and systems for performing a drip demonstration are provided. A person skilled in the art will appreciate that the present invention can be practiced by other than the described embodiments, which are presented for purposes of illustration rather than limitation.

What is claimed is:

1. A composition comprising:
a base material; and
active particles in contact with the base material, wherein the active particles exhibit exothermic properties that improve the moisture management properties of the composition.

2. The composition of claim 1, wherein the composition dries faster than, or requires less drying energy than, the base material without the active particles.

3. The composition of claim 1, wherein the active particles comprise activated carbon or zeolites.

4. The composition of claim 1, wherein the active particles comprise about 0% to about 75% of the composition.

5. The composition of claim 1, wherein the active particles comprise about 30% to about 50% of the composition.

6. The composition of claim 1, wherein the active particles comprise about 0% to about 30% of the composition.

7. The composition of claim 1, wherein the active particles comprise about 0% to about 50% of the composition.

8. The composition of claim 1, wherein the active particles are selected from the group consisting of activated carbon, graphite, aluminum oxide (activated alumina), silica gel, soda ash, aluminum trihydrate, baking soda, p-methoxy-2-ethoxyethyl ester Cinnamic acid (cinoxate), zinc oxide, zeolites, titanium dioxide, molecular filter material, and any combination thereof.

9. The composition of claim 1, wherein the base material is selected from the group consisting of polyesters, nylons, polyacrylics, thermalplastics, PTFEs, polycarbonates, polyalkanes, poly-vinyl compounds, epoxies, siloxane based reaction polymers, glues, cross-linking polymers, fibers, cotton, acetates, acrylics, aramids, bicomponents, lyocells, melamines, modacrylics, olefins, PBIs, rayons, spandexes, water, oils, aerosols, perfumes and any combination thereof.

10. The composition of claim 1, wherein the composition is selected from the group consisting of bags, foam, plastic components, upholstery, carpeting, rugs, mats, sheets, towels, rugs, pet beds, mattress pads, mattresses, curtains, filters, shoes, insoles, diapers, shirts, pants, blouses, undergarments, protective suits, and any combination thereof.

11. A method of producing an exothermically enhanced article, the method comprising:
encapsulating a plurality of active particles with at least one removable encapsulant to produce encapsulated active particles, wherein the active particles are capable of exhibiting exothermic properties; and
mixing the encapsulated particles with a base material to obtain a mixture, wherein the at least one removable encapsulant is removable to impart the exothermic properties of the active materials to the mixture to produce the exothermically enhanced article.

12. The method of claim 11, wherein the encapsulating and the mixing are performed in a single step.

13. The method of claim 11, further comprising removing at least a portion of the encapsulant from the encapsulated active particles.

14. The method of claim 13, wherein the removing comprises dissolving the encapsulant or evaporating the encapsulant.

15. The method of claim 13, wherein the removable encapsulant deactivates the active particles and the removing comprises reactivating the active particles.

16. A method for determining a drying time of an article, the method comprising:
measuring under a set of testing conditions an initial equilibrium temperature of an article having diffused therein an amount of a liquid;
monitoring the temperature of the article under the set of testing conditions to detect a substantially rapid rise in temperature;
determining under the same testing conditions a final equilibrium temperature after the substantially rapid rise is detected; and
computing the drying time of the article based on the initial equilibrium temperature and the final equilibrium temperature.

17. The method of claim 16, wherein computing the drying time of the article comprises determining the difference between the initial equilibrium temperature and the final equilibrium temperature.

18. The method of claim 16 further comprising artificially creating the set of testing conditions in a testing environment using a demonstration unit to control the relative humidity and temperature of the testing environment.

19. The method of claim 16 further comprising diffusing a predetermined amount of liquid in the article.

20. A performance-enhanced paint comprising:
a solvent having diffused therein a base paint material; and
active particles in contact with the solvent, wherein the active particles exhibit exothermic properties that are capable of increasing evaporation of the solvent to produce a performance-enhanced paint having a reduced drying time.

21. The performance-enhanced paint of claim 20, further comprising:
a removable protective substance that prevents at least a portion of the active particles from being substantially deactivated by other substance or matter prior to removal of the removable protective substance, and wherein the removable protective substance is removable to reactivate the portion of active particles to produce the performance-enhanced paint.

22. The performance-enhanced paint of claim 20, wherein the solvent is selected from the group consisting of an organic solvent and an aqueous solvent.

23. The performance-enhanced paint of claim 20, wherein the base paint material is selected from the group consisting of a polyurethane and a polyacyclic paint.

24. The performance-enhanced paint of claim 20, wherein the active particles are selected from the group consisting of activated carbon, graphite, aluminum oxide (activated alumina), silica gel, soda ash, aluminum trihydrate, baking soda, p-methoxy-2-ethoxyethyl ester Cinnamic acid (cinoxate), zinc oxide, zeolites, titanium dioxide, molecular filter material, and any combination thereof.

25. A method of producing performance-enhanced paint, the method comprising:
mixing active particles that are capable of exhibiting exothermic properties with a solvent having diffused therein a base paint material to obtain a paint mixture, wherein the exothermic properties of the active particles reduce the drying time of the paint mixture.

26. The method of claim 25 further comprising encapsulating a plurality of the active particles with at least one removable encapsulant to produce encapsulated active particles, wherein the encapsulated active particles improve the drying time of the paint mixture.

27. The method of claim 26, wherein the encapsulating and the mixing are performed in a single step.

28. The method of claim 26, further comprising removing at least a portion of the encapsulant from the encapsulated active particles.

29. The method of claim 26, wherein the removable encapsulant deactivates the active particles, the method further comprising: removing the removable encapsulant during application or drying of the paint to reactivate the active particles.

30. The method of claim 25, wherein mixing the active particles with the solvent having diffused therein a base paint material comprises incorporating the active particles into the solvent having diffused therein the base paint material during application or use of the paint.

31. The method of claim 25, wherein mixing the active particles with the solvent having diffused therein a base paint material comprises incorporating the active particles into the solvent having diffused therein the base paint material during production of the paint.

32. A drip demonstration unit for comparing the dry time of at least two fabrics, the unit comprising for each of the at least two fabrics:
a mounting mechanism for holding a respective fabric;
a water delivery system for dropping water on the respective fabric; and
a fan for blowing air on the respective fabric,
wherein the water delivery system drops water substantially equal to each of the other water delivery systems for the other fabrics, and wherein the fan blows air substantially equally to each of the other fans for the other fabrics.

33. The drip demonstration unit of claim 32 wherein the mounting mechanism is an embroidery hoop.

34. The drip demonstration unit of claim 32 wherein the water delivery system is selected from the group consisting of a parastalic pump and a separatory funnel.

35. The drip demonstration unit of claim 32 wherein the mounting mechanism positions the fabric over the fan.
